(19) United States
(12) Patent Application Publication
(10) Pub. No.: US 2026/0343341 A1
(43) Pub. Date: Oct. 29, 2026

(54) HANDOVER PROCEDURE IN WIRELESS COMMUNICATION

(71) Applicant: APPLE INC., Cupertino, CA (US)

(72) Inventors: Peng Cheng, Beijing (CN); Naveen Kumar R Palle Venkata, San Diego, CA (US); Zhibin Wu, Los Altos, CA (US); Alexander Sirotkin, Hod Hasharon (IL); Haijing Hu, Los Gatos, CA (US); Ping-Heng Kuo, London (GB); Ralf Rossbach, Munich (DE); Yuqin Chen, Beijing (CN); Fangli Xu, Beijing (CN)

(21) Appl. No.: 18/997,369

(22) PCT Filed: Aug. 8, 2022
(86) PCT No.: PCT/CN2022/110820

§ 371 Date: Jan. 21, 2025

(51) Int. Cl. H04W 36/00; H04W 76/27

(52) U.S. Cl. CPC H04W 36/0072; H04W 36/0058; H04W 76/27

(57) ABSTRACT

Apparatuses, systems, and methods for handover procedure in wireless communication. A target network device is configured to: transmit, to a target network device, a handover request to request handover of a remote wireless device which is served by the source network device or a source relay wireless device served by the source network device, the handover request comprising identification information of one or more candidate relay wireless devices served by the target network device; and receive, from the target network device, a handover response; and in response to the handover response comprising a container, transmit a handover command comprising the container to the remote wireless device, the container comprising identification information of a target relay wireless device selected by the target network device from the one or more candidate relay wireless devices or cell identification information of the target network device.

### TECHNICAL FIELD

This application relates generally to wireless communication, including apparatus, systems, and methods for handover procedure in wireless communication.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### SUMMARY

The present disclosure provides apparatus, systems, and methods for handover procedure in wireless communication.

Embodiments disclosed herein include a source network device, comprising: at least one antenna; and a processor configured to: transmit, to a target network device, a handover request to request handover of a remote wireless device which is served by the source network device or a source relay wireless device served by the source network device, the handover request comprising identification information of one or more candidate relay wireless devices served by the target network device; and receive, from the target network device, a handover response; and in response to the handover response comprising a container, transmit a handover command comprising the container to the remote wireless device, the container comprising identification information of a target relay wireless device selected by the target network device from the one or more candidate relay wireless devices to serve the remote wireless device or cell identification information of the target network device to serve the remote wireless device.

Embodiments disclosed herein include a target network device, comprising: at least one antenna; and a processor configured to: receive, from a source network device, a handover request to request handover of a remote wireless device which is served by the source network device or a source relay wireless device served by the source network device, the handover request comprising identification information of one or more candidate relay wireless devices served by the target network device; select a target relay wireless device from the one or more candidate relay wireless devices or the target network device itself to serve the remote wireless device; and transmit, to the source network device, a handover response, wherein if the target relay wireless device or the target network device itself is selected to serve the remote wireless device, the handover response comprises a container, the container comprising identification information of the target relay wireless device to serve the remote wireless device or cell identification information of the target network device to serve the remote wireless device.

Embodiments disclosed herein include a method performed by a source network device, comprising: transmitting, to a target network device, a handover request to request handover of a remote wireless device which is served by the source network device or a source relay wireless device served by the source network device, the handover request comprising identification information of one or more candidate relay wireless devices served by the target network device; and receiving, from the target network device, a handover response; and in response to the handover response comprising a container, transmitting a handover command comprising the container to the remote wireless device, the container comprising identification information of a target relay wireless device selected by the target network device from the one or more candidate relay wireless devices to serve the remote wireless device or cell identification information of the target network device to serve the remote wireless device.

Embodiments disclosed herein include a method performed by a target network device, comprising: receiving, from a source network device, a handover request to request handover of a remote wireless device which is served by the source network device or a source relay wireless device served by the source network device, the handover request comprising identification information of one or more candidate relay wireless devices served by the target network device; selecting a target relay wireless device from the one or more candidate relay wireless devices or the target network device itself to serve the remote wireless device; and transmitting, to the source network device, a handover response, wherein if the target relay wireless device or the target network device itself is selected to serve the remote wireless device, the handover response comprises a container, the container comprising identification information of the target relay wireless device to serve the remote wireless device or cell identification information of the target network device to serve the remote wireless device.

Embodiments disclosed herein include a non-transitory computer-readable storage medium, having instructions stored thereon, which, when executed by a processor of a source network device, cause the processor to: transmit, to a target network device, a handover request to request handover of a remote wireless device which is served by the source network device or a source relay wireless device served by the source network device, the handover request comprising identification information of one or more candidate relay wireless devices served by the target network device; and receive, from the target network device, a handover response; and in response to the handover response comprising a container, transmit a handover command comprising the container to the remote wireless device, the container comprising identification information of a target relay wireless device selected by the target network device from the one or more candidate relay wireless devices to serve the remote wireless device or cell identification information of the target network device to serve the remote wireless device.

Embodiments disclosed herein include a non-transitory computer-readable storage medium, having instructions stored thereon, which, when executed by a processor of a target network device, cause the processor to: receive, from a source network device, a handover request to request handover of a remote wireless device which is served by the source network device or a source relay wireless device served by the source network device, the handover request comprising identification information of one or more candidate relay wireless devices served by the target network device; select a target relay wireless device from the one or more candidate relay wireless devices or the target network device itself to serve the remote wireless device; and transmit, to the source network device, a handover response, wherein if the target relay wireless device or the target network device itself is selected to serve the remote wireless device, the handover response comprises a container, the container comprising identification information of the target relay wireless device to serve the remote wireless device or cell identification information of the target network device to serve the remote wireless device.

Embodiments disclosed herein include a computer program product, comprising computer program instructions stored thereon, which, when executed by a processor of a source wireless device, cause the processor to: transmit, to a target network device, a handover request to request handover of a remote wireless device which is served by the source network device or a source relay wireless device served by the source network device, the handover request comprising identification information of one or more candidate relay wireless devices served by the target network device; and receive, from the target network device, a handover response; and in response to the handover response comprising a container, transmit a handover command comprising the container to the remote wireless device, the container comprising identification information of a target relay wireless device selected by the target network device from the one or more candidate relay wireless devices to serve the remote wireless device or cell identification information of the target network device to serve the remote wireless device.

Embodiments disclosed herein include a computer program product, comprising computer program instructions stored thereon, which, when executed by a processor of a target wireless device, cause the processor to: receive, from a source network device, a handover request to request handover of a remote wireless device which is served by the source network device or a source relay wireless device served by the source network device, the handover request comprising identification information of one or more candidate relay wireless devices served by the target network device; select a target relay wireless device from the one or more candidate relay wireless devices or the target network device itself to serve the remote wireless device; and transmit, to the source network device, a handover response, wherein if the target relay wireless device or the target network device itself is selected to serve the remote wireless device, the handover response comprises a container, the container comprising identification information of the target relay wireless device to serve the remote wireless device or cell identification information of the target network device to serve the remote wireless device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3A to 3C illustrate example scenarios of Inter-gNB handover, according to embodiments disclosed herein.

FIG. 4 illustrates an example relay discovery of a remote UE towards a relay UE in a neighboring cell, according to embodiments disclosed herein.

FIG. 5 illustrates an example communication procedure of Inter-gNB handover, according to embodiments disclosed herein.

FIG. 6 illustrates an example communication procedure of conditional Inter-gNB handover, according to embodiments disclosed herein.

FIG. 7 illustrates an example method performed by a source network device, according to embodiments disclosed herein.

FIG. 8 illustrates an example method performed by a target network device, according to embodiments disclosed herein.

### DETAILED DESCRIPTION

Various embodiments are described with regard to a UE. However, reference to a UE is merely provided for illustrative purposes. The example embodiments may be utilized with any wireless device that may establish a connection to a network and is configured with the hardware, software, and/or firmware to exchange information and data with the network. Therefore, the UE as described herein is used to represent any appropriate wireless device.

Various embodiments are described with regard to a gNB. However, reference to a gNB is merely provided for illustrative purposes. The example embodiments may be utilized with any network device in a network and is configured with the hardware, software, and/or firmware to implement any function of the network. Therefore, the gNB as described herein is used to represent any appropriate network device.

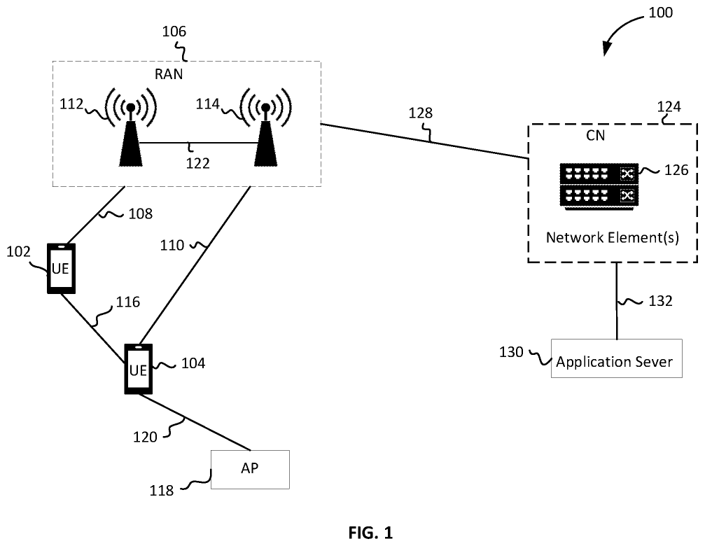

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services).

The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

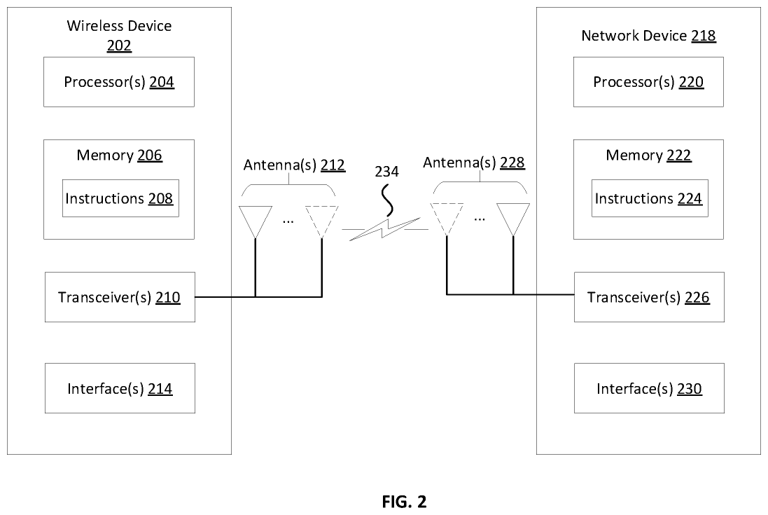

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

In a UE-to-network relay system, a relay UE relays the traffic between a remote UE and a network. The UE-to-network relay enables coverage extension and power saving for the remote UE. A group of remote UEs can rely on an individual relay UE to communicate with a network.

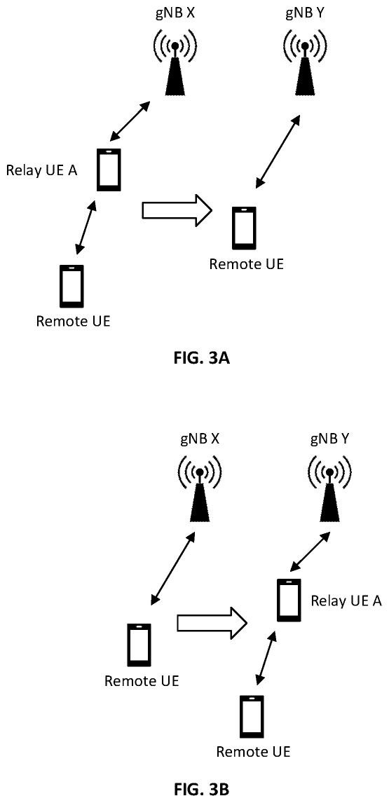

FIG. 3A to 3C illustrate example scenarios of Inter-gNB handover, according to embodiments disclosed herein. For direct path, the remote UE will connect to network directly. For indirect path, the remote UE will connect to network via a relay UE. FIG. 3A illustrates a scenario of Inter-gNB indirect-to-direct path switching (i.e., “remote UE <-> relay UE A <-> gNB X” to “remote UE <-> gNB Y”). FIG. 3B illustrates a scenario of Inter-gNB direct-to-indirect path switching (i.e., “remote UE <-> gNB X” to “remote UE <-> relay UE A <-> gNB Y”). FIG. 3C illustrates a scenario of Inter-gNB indirect-to-indirect path switching (i.e., “remote UE <-> relay UE A <-> gNB X” to “remote UE <-> relay UE B <-> gNB Y”).

The target relay UE can be in RRC connected state or RRC idle/inactive state. The remote UE will use two different connection setup procedures for the target relay UE in RRC connected state and RRC idle/inactive state. The gNB's handover command will tell remote UE which connection setup procedure to use. That is, if the target relay UE is in RRC connected state (i.e., gNB-controlled), then gNB will provide a dedicated RLC channel configuration for sending RRCReconfigurationComplete message. Otherwise, UE must use default RLC channel configuration.

For indirect-path to indirect-path under the same gNB, gNB knows whether a candidate relay UE is in RRC connected state or not. It is up to gNB implementation to decide which relay UE to choose. However, for direct path to indirect-path under different gNBs or indirect-path to indirect-path under different gNBs, the source gNB does not know the RRC state of the candidate relay UE. Thus, extra query procedure may be required for RRC state of candidate relay UEs. In addition, the source gNB does not know Uu quality of candidate relay UEs (towards target gNB). Therefore, extra query procedure may be required for Uu quality of candidate relay UEs (towards target gNB).

Embodiments contemplated herein let the target gNB determine whether itself or its relay UE to serve the remote UE. Target gNB knows the RRC state of the candidate relay UEs, and the Uu quality (RSRP/RSRQ/SINR) of the candidate relay UEs. Therefore, the target gNB is in a better position to determine target relay UE, to avoid extra inter-gNB exchange on RRC state and/or Uu quality of candidate relay UEs.

In some embodiments of the present disclosure, the source gNB may select a target gNB, but it doesn't determine whether the target gNB or its relay UE to serve the remote UE.

Source gNB forwards the following information to its selected target gNB via Handover Request message: Uu measurements of remote UE towards target gNB, SD-RSRP/SL-RSRP of the remote UE towards candidate relay UEs which are served by target gNB, and Lay 2 identifiers (L2 IDs) of candidate relay UEs which are served by target gNB.

The target gNB may prepare configuration in target cell, and transparently forwards information of the serving node (target gNB or target relay UE) and the prepared configuration to the source gNB via handover response. Thus, RRC state of the target relay UE can be transparent to the source gNB.

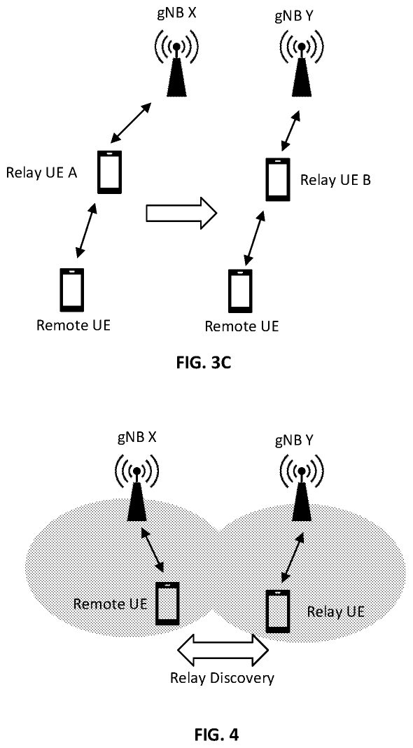

FIG. 4 illustrates an example relay discovery of a remote UE towards a relay UE in a neighboring cell, according to embodiments disclosed herein. The remote UE in the cell of gNB X discovers the relay UE in the cell of gNB Y, and wants to switch its path to the relay UE. Though the remote UE is shown to be connected directly to gNB X, it may also be connected indirectly to gNB X via a relay UE.

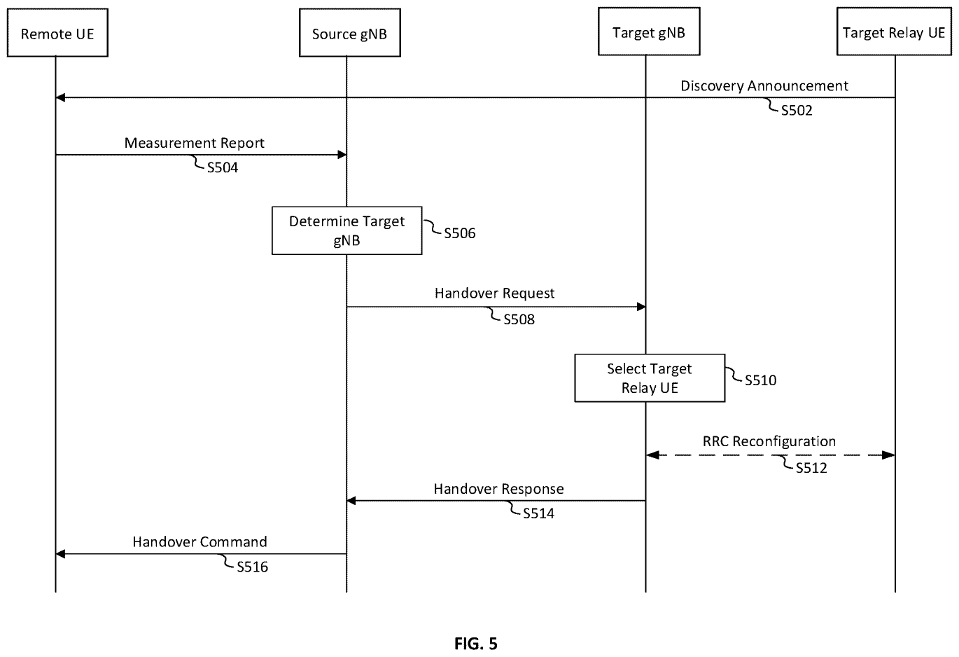

FIG. 5 illustrates an example communication procedure of Inter-gNB handover, according to embodiments disclosed herein.

Firstly, candidate relay UEs transmit discovery announcements for relay discovery.

For example, a relay UE which will be chosen as a target relay UE transmits a discovery announcement for relay discovery at step S502. Though not shown, there are other candidate relay UEs which transmit discovery announcement. Each of the discovery announcements may include identification information of a respective relay UE (e.g., L2 ID of the relay UE), cell identification information (e.g., serving cell ID), a relay service code and a PLMN ID.

At step S504, the remote UE transmits a measurement report to a source gNB serving the remote UE, after receiving the discovery announcements. The measurement report may include identification information of the candidate relay UEs, the cell identification information, and measurement results of the remote UE towards the candidate relay UEs (e.g., SD-RSRP/SL-RSRP and/or sidelink beam information of the measured relay UE). In addition, the measurement report may include measurement results of the remote UE towards a candidate gNB indicated by the cell identification information. The candidate relay UEs may be served by a plurality of candidate gNBs, and the plurality of candidate gNBs can be indicated by the cell identification information associated with the identification information of the candidate relay UEs.

At step S506, the source gNB determines a target gNB based on the measurement report received from the remote UE. In some embodiments of the present disclosure, the source gNB determines all the candidate gNBs indicated by the measurement report as target gNBs. In some embodiments of the present disclosure, the source gNB selects a target gNB from a plurality of candidate gNBs indicated by the measurement report. The selection of the target gNB may be based on the measurement results of the remote UE towards the candidate gNBs and/or the measurement results of the remote UE towards the candidate relay UEs. For example, the selection of the target gNB may be based on one of the following: average of Uu RSRP of a candidate gNB and SD-RSRP/SL-RSRP of all its candidate relay UEs, average of Uu RSRP of a candidate gNB and max (SD-RSRP/SL-RSRP of all its candidate relay UEs), max [Uu RSRP of a candidate gNB, max (SD-RSRP/SL-RSRP of all its candidate relay UEs)], or min [Uu RSRP of a candidate gNB, max (SD-RSRP/SL-RSRP of all its candidate relay UEs)].

At step S508, the source gNB transmits a handover request to the target gNB. The handover request may include identification information of candidate relay UEs served by the target gNB. The handover request may further include cell identification information of the target gNB, measurement results of the remote UE towards the candidate relay UEs, and/or a measurement result of the remote UE towards the target gNB.

At step S510, the target gNB selects a target relay UE from the candidate relay UEs or itself to serve the remote UE, after receiving the handover request from the source gNB. The selection may be based on an RRC state of the candidate relay UEs. A relay UE in RRC connected state may be chosen. In addition, the measurement results of the remote UE towards the candidate relay UEs may also be considered. For example, a relay UE with high SD-RSRP/SL-RSRP and/or with a measured sidelink beam similar to its Uu beam may be chosen. In some embodiments of the present disclosure, the target gNB may decide to serve the remote UE by itself if the measurement result of the remote UE towards the target gNB is good enough.

If the selected target relay UE is in RRC connected state, the target gNB transmits an RRC reconfiguration message to the selected target relay UE at step S512, so as to reconfigure a dedicated bearer mapping (i.e., Sidelink Relay Adaptation Protocol (SRAP) bearer mapping) for the target relay UE.

At step S514, the target gNB transmits a handover response to the source gNB. If a target relay UE or the target gNB itself is selected to serve the remote UE, the handover response may include a container. The container may comprise identification information of the target UE to serve the remote UE or cell identification information of the target gNB to serve the remote UE. If a target relay UE is selected to serve the remote UE, the container may include identification information of the target relay UE. If the target gNB decides to serve the remote UE by itself, the container may include cell identification information of the target gNB. If none of the candidate relay UEs is found (e.g., if relay UE has reselected to another gNB or its L2 ID has changed), the handover response may comprise a failure cause value indicating that the candidate relay UEs are not found.

The handover response may be a path switch command prepared by the target gNB depending on the RRC state of the target relay UE. For example, if the selected target relay UE is in RRC connected state, the container in the handover response may comprise a configuration of the Sidelink Relay Adaptation Protocol (SRAP) bearer mapping. Otherwise, if the selected target relay UE is in RRC idle/inactive state, the container in the handover response does not comprise such a configuration of SRAP bearer mapping.

The target gNB may further assign identification information to the remote UE, and include the assigned identification information in the container. The identification information assigned to the remote wireless device may be used at least in a Sidelink Relay Adaptation Protocol (SRAP) header. The assigned identification information may be a local ID of remote UE to be used in the SRAP header for security issue. If real remote UE ID is included in the SRAP header, it will cause some security issue because adaptation layer has no security protection.

The container in the handover response may be transparent to the source gNB. That is to say, the source gNB may send the container to the remote UE without interpreting it. Thus, the source gNB does not need to know the RRC state of the target relay UE.

At step S516, in response to the handover response comprising a container, the source gNB transmits a handover command comprising the container to the remote UE, so as to instruct the remote UE to perform handover. The handover command may include the container in the handover response, and may be transmitted in form of a RRC reconfiguration message with a field of Reconfig WithSync. Upon receiving the handover command, the remote UE may determine the RRC state of the target relay UE based on the container in the handover command (i.e. whether dedicated SRAP bearer mapping configuration is present), and perform path switch execution accordingly.

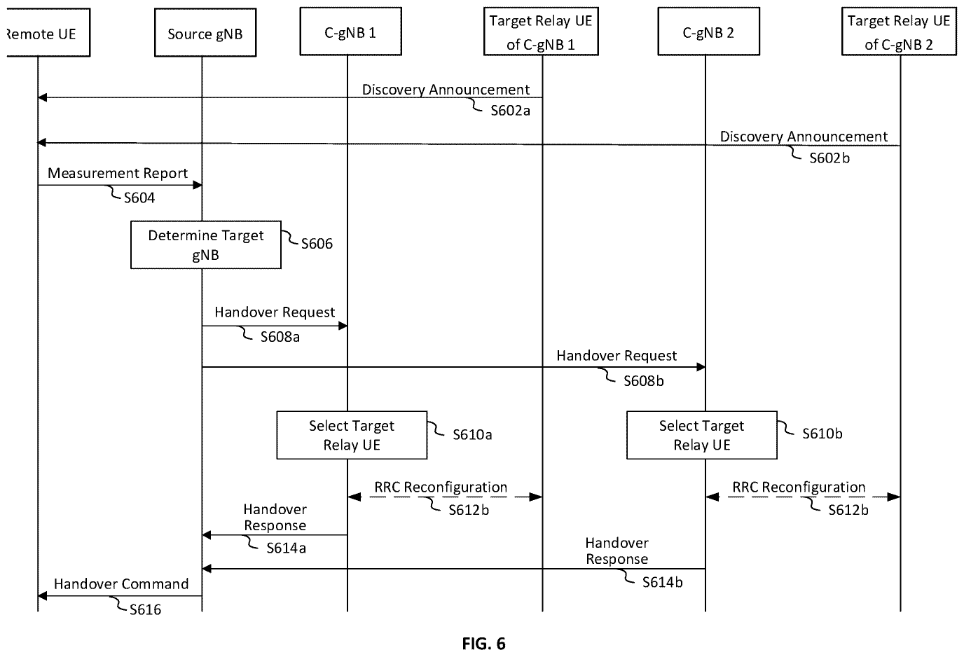

Similar communication procedure can be applied to conditional handover of a remote UE. FIG. 6 illustrates an example communication procedure of conditional Inter-gNB handover, according to embodiments disclosed herein. The conditional handover procedure of FIG. 6 is different from the handover procedure of FIG. 5 in that two candidate gNBs (C-gNB1 and C-gNB2) are selected by the source gNB as target gNBs. Therefore, the source gNB not only transmits a handover request to C-gNB1, but also transmits a handover request to C-gNB2. In addition, each of C-gNB1 and C-gNB2 will select a target relay UE and transmits a handover response to the source gNB.

Firstly, candidate relay UEs transmit discovery announcements for relay discovery. For example, a relay UE of C-gNB1 which will be chosen as a target relay UE transmits a discovery announcement for relay discovery at step S602a, and a relay UE of C-gNB2 which will be chosen as a target relay UE transmits a discovery announcement for relay discovery at step S602b. Though not shown, there are other candidate relay UEs which transmit discovery announcement. At step S604, the remote UE transmits a measurement report to a source gNB serving the remote UE, after receiving the discovery announcements. At step S606, the source gNB determines target gNBs based on the measurement report received from the remote UE. It is shown in FIG. 6 that two candidate gNBs (C-gNB1 and C-gNB2) are selected by the source gNB as target gNBs. However, the source gNB may select more candidate gNBs as target gNBs in some embodiments of the present disclosure.

At step S608a, the source gNB transmits a handover request to C-gNB1. At step S608a, the source gNB transmits a handover request to C-gNB2.

At step S610a, the C-gNB1 selects a target relay UE from its candidate relay UEs or itself to serve the remote UE, after receiving the handover request from the source gNB. If the selected target relay UE is in RRC connected state, C-gNB1 transmits an RRC reconfiguration message to the selected target relay UE at step S612a, so as to reconfigure a dedicated bearer mapping (i.e., Sidelink Relay Adaptation Protocol (SRAP) bearer mapping) for the target relay UE. At step S614a, C-gNB1 transmits a handover response to the source gNB.

At step S610b, the C-gNB2 selects a target relay UE from its candidate relay UEs or itself to serve the remote UE after receiving the handover request from the source gNB. If the selected target relay UE is in RRC connected state, C-gNB2 transmits an RRC reconfiguration message to the selected target relay UE at step S612b, so as to reconfigure a dedicated bearer mapping (i.e., Sidelink Relay Adaptation Protocol (SRAP) bearer mapping) for the target relay UE. At step S614b, C-gNB2 transmits a handover response to the source gNB.

At step S616, in response to the handover response from the C-gNB1 and/or the C-gNB2 comprising a container, the source gNB transmits a handover command to the remote UE, so as to instruct the remote UE to perform handover. The handover command comprises the container in the handover response from the C-gNB1 and/or the C-gNB2.

The communication procedure of FIG. 6 is similar to the communication procedure of FIG. 5. Therefore, the signaling exchanged between UEs and gNBs are not described in detail, since they may be the same as those in the communication procedure of FIG. 5.

Various embodiments are described above with regard to UE and gNB. However, as indicated previously, the UE as described herein is used to represent any appropriate wireless device, and the gNB as described herein is used to represent any appropriate network device.

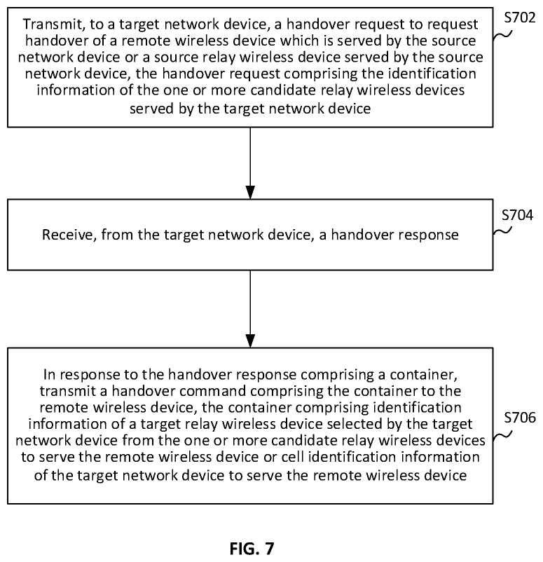

FIG. 7 illustrates an example method performed by a source network device, according to embodiments disclosed herein.

At step S702, the source network device transmits, to a target network device, a handover request to request handover of a remote wireless device which is served by the source network device or a source relay wireless device served by the source network device, the handover request comprising the identification information of the one or more candidate relay wireless devices served by the target network device.

At step S704, the source network device receives, from the target network device, a handover response.

At step S706, in response to the handover response comprising a container, the source network device transmits a handover command comprising the container to the remote wireless device, the container comprising identification information of a target relay wireless device selected by the target network device from the one or more candidate relay wireless devices to serve the remote wireless device or cell identification information of the target network device to serve the remote wireless device.

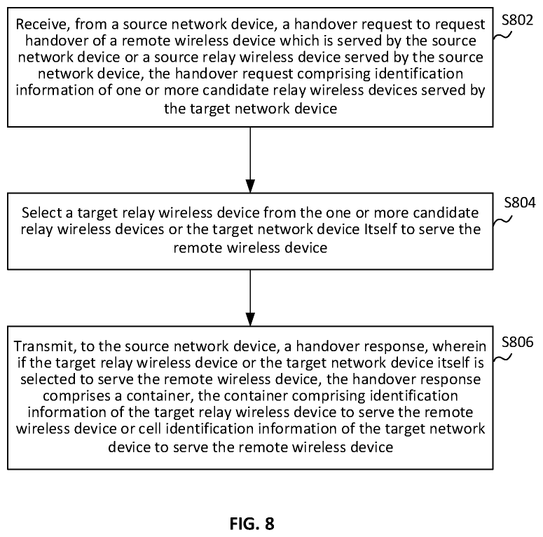

FIG. 8 illustrates an example method performed by a target network device, according to embodiments disclosed herein.

At step S802, the target network device receives, from a source network device, a handover request to request handover of a remote wireless device which is served by the source network device or a source relay wireless device served by the source network device, the handover request comprising identification information of one or more candidate relay wireless devices served by the target network device.

At step S804, the target network device selects a target relay wireless device from the one or more candidate relay wireless devices or the target network device to serve the remote wireless device.

At step S806, the target network device transmits, to the source network device, a handover response, wherein if the target relay wireless device or the target network device itself is selected to serve the remote wireless device, the handover response comprises a container, the container comprising identification information of the target relay wireless device to serve the remote wireless device or cell identification information of the target network device to serve the remote wireless device.

Embodiments contemplated herein include a source network device, comprising: at least one antenna; and a processor configured to: transmit, to a target network device, a handover request to request handover of a remote wireless device which is served by the source network device or a source relay wireless device served by the source network device, the handover request comprising identification information of one or more candidate relay wireless devices served by the target network device; and receive, from the target network device, a handover response; and in response to the handover response comprising a container, transmit a handover command comprising the container to the remote wireless device, the container comprising identification information of a target relay wireless device selected by the target network device from the one or more candidate relay wireless devices to serve the remote wireless device or cell identification information of the target network device to serve the remote wireless device.

In some embodiments of the present disclosure, the processor is further configured to receive, from the remote wireless device, a measurement report comprising cell identification information of the target network device, the identification information of the one or more candidate relay wireless devices served by the target network device, and measurement results of the remote wireless device towards the one or more candidate relay wireless devices.

In some embodiments of the present disclosure, the measurement report comprises cell identification information of a plurality of network devices, identification information of a plurality of candidate relay wireless devices served by the plurality of network devices, and measurement results of the remote wireless device towards the plurality of candidate relay wireless devices, and wherein the processor is further configured to select the target network device from the plurality of network devices based on the measurement report.

In some embodiments of the present disclosure, the measurement report further comprises measurement results of the remote wireless device towards the plurality of network devices.

In some embodiments of the present disclosure, the handover request further comprises the measurement results of the remote wireless device towards the one or more candidate relay wireless devices.

In some embodiments of the present disclosure, the handover request further comprises a measurement result of the remote wireless device towards the target network device.

In some embodiments of the present disclosure, the identification information of the one or more candidate relay wireless devices comprises at least Layer 2 identifiers (L2 IDs) In some embodiments of the present disclosure, the container further comprises a configuration of a Sidelink Relay Adaptation Protocol (SRAP) bearer mapping.

In some embodiments of the present disclosure, the handover response comprises a failure cause value indicating that the one or more candidate relay wireless devices are not found.

In some embodiments of the present disclosure, the container is transparent to the source network device.

In some embodiments of the present disclosure, the processor is further configured to: transmit, to another target network device, another handover request to request handover of the remote wireless device, the handover request comprising identification information of one or more other candidate relay wireless devices served by the another target network device; and receive, from the another target network device, another handover response comprising another container, the another container comprising identification information of another target relay wireless device selected by the another target network device from the one or more other candidate relay wireless devices to serve the remote wireless device or cell identification information of the another target network device to serve the remote wireless device.

Embodiments contemplated herein include an apparatus comprising means to perform one or more elements of a method comprising: transmitting, to a target network device, a handover request to request handover of a remote wireless device which is served by a source network device or a source relay wireless device served by the source network device, the handover request comprising identification information of one or more candidate relay wireless devices served by the target network device; and receiving, from the target network device, a handover response; and in response to the handover response comprising a container, transmit a handover command comprising the container to the remote wireless device, the container comprising identification information of a target relay wireless device selected by the target network device from the one or more candidate relay wireless devices to serve the remote wireless device or cell identification information of the target network device to serve the remote wireless device. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of a method comprising: transmitting, to a target network device, a handover request to request handover of a remote wireless device which is served by a source network device or a source relay wireless device served by the source network device, the handover request comprising identification information of one or more candidate relay wireless devices served by the target network device; and receiving, from the target network device, a handover response; and in response to the handover response comprising a container, transmit a handover command comprising the container to the remote wireless device, the container comprising identification information of a target relay wireless device selected by the target network device from the one or more candidate relay wireless devices to serve the remote wireless device or cell identification information of the target network device to serve the remote wireless device. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of a method comprising: transmitting, to a target network device, a handover request to request handover of a remote wireless device which is served by a source network device or a source relay wireless device served by the source network device, the handover request comprising identification information of one or more candidate relay wireless devices served by the target network device; and receiving, from the target network device, a handover response; and in response to the handover response comprising a container, transmit a handover command comprising the container to the remote wireless device, the container comprising identification information of a target relay wireless device selected by the target network device from the one or more candidate relay wireless devices to serve the remote wireless device or cell identification information of the target network device to serve the remote wireless device. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of a method comprising: transmitting, to a target network device, a handover request to request handover of a remote wireless device which is served by a source network device or a source relay wireless device served by the source network device, the handover request comprising identification information of one or more candidate relay wireless devices served by the target network device; and receiving, from the target network device, a handover response; and in response to the handover response comprising a container, transmit a handover command comprising the container to the remote wireless device, the container comprising identification information of a target relay wireless device selected by the target network device from the one or more candidate relay wireless devices to serve the remote wireless device or cell identification information of the target network device to serve the remote wireless device. This apparatus may be, for example, an apparatus of a UE (such as a wireless device 202 that is a UE, as described herein).

Embodiments contemplated herein include a signal as described in or related to one or more elements of a method comprising: transmitting, to a target network device, a handover request to request handover of a remote wireless device which is served by a source network device or a source relay wireless device served by the source network device, the handover request comprising identification information of one or more candidate relay wireless devices served by the target network device; and receiving, from the target network device, a handover response; and in response to the handover response comprising a container, transmit a handover command comprising the container to the remote wireless device, the container comprising identification information of a target relay wireless device selected by the target network device from the one or more candidate relay wireless devices to serve the remote wireless device or cell identification information of the target network device to serve the remote wireless device.

Embodiments contemplated herein include a computer program or computer program product comprising instructions, wherein execution of the program by a processor is to cause the processor to carry out one or more elements of a method comprising: transmitting, to a target network device, a handover request to request handover of a remote wireless device which is served by a source network device or a source relay wireless device served by the source network device, the handover request comprising identification information of one or more candidate relay wireless devices served by the target network device; and receiving, from the target network device, a handover response; and in response to the handover response comprising a container, transmit a handover command comprising the container to the remote wireless device, the container comprising identification information of a target relay wireless device selected by the target network device from the one or more candidate relay wireless devices to serve the remote wireless device or cell identification information of the target network device to serve the remote wireless device. These instructions may be, for example, located in the processor and/or on a memory of the UE (such as a memory 206 of a wireless device 202 that is a UE, as described herein).

Embodiments contemplated herein include a target network device, comprising: at least one antenna; and a processor configured to: receive, from a source network device, a handover request to request handover of a remote wireless device which is served by the source network device or a source relay wireless device served by the source network device, the handover request comprising identification information of one or more candidate relay wireless devices served by the target network device; select a target relay wireless device from the one or more candidate relay wireless devices or the target network device to serve the remote wireless device; and transmit, to the source network device, a handover response, wherein if the target relay wireless device or the target network device itself is selected to serve the remote wireless device, the handover response comprises a container, the container comprising identification information of the target relay wireless device to serve the remote wireless device or cell identification information of the target network device to serve the remote wireless device.

In some embodiments of the present disclosure, the target relay wireless device is selected based at least on a Radio Resource Control (RRC) state of the target relay wireless device.

In some embodiments of the present disclosure, the handover request further comprises a measurement result of the remote wireless device towards the target network device, and the processor is configured to select the target relay wireless device or the target network device itself to serve the remote wireless device based at least on the measurement result of the remote wireless device towards the target network device.

In some embodiments of the present disclosure, the handover request further comprises measurement results of the remote wireless device towards the one or more candidate relay wireless devices, and the processor is configured to select the target relay wireless device or the target network device itself to serve the remote wireless device based at least on the measurement results of the remote wireless device towards the one or more candidate relay wireless devices.

In some embodiments of the present disclosure, the processor is further configured to transmit an RRC reconfiguration message to the target relay wireless device if the target relay wireless device is in an RRC connected state, so as to reconfigure a Sidelink Relay Adaptation Protocol (SRAP) bearer mapping for the target relay wireless device.

In some embodiments of the present disclosure, the container further comprises a configuration of the Sidelink Relay Adaptation Protocol (SRAP) bearer mapping.

In some embodiments of the present disclosure, the processor is further configured to assign identification information to the remote wireless device, and wherein the container further comprises the identification information of the remote wireless device.

In some embodiments of the present disclosure, the identification information assigned to the remote wireless device is used at least in a Sidelink Relay Adaptation Protocol (SRAP) header.

In some embodiments of the present disclosure, if none of the one or more candidate relay wireless devices is found, the handover response comprises a failure cause value indicating that the one or more candidate relay wireless devices are not found.

In some embodiments of the present disclosure, the container is transparent to the source network device.

Embodiments contemplated herein include an apparatus comprising means to perform one or more elements of a method comprising: receiving, from a source network device, a handover request to request handover of a remote wireless device which is served by the source network device or a source relay wireless device served by the source network device, the handover request comprising identification information of one or more candidate relay wireless devices served by the target network device; selecting a target relay wireless device from the one or more candidate relay wireless devices or a target network device itself to serve the remote wireless device; and transmitting, to the source network device, a handover response, wherein if the target relay wireless device or the target network device itself is selected to serve the remote wireless device, the handover response comprises a container, the container comprising identification information of the target relay wireless device to serve the remote wireless device or cell identification information of the target network device to serve the remote wireless device. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of a method comprising: receiving, from a source network device, a handover request to request handover of a remote wireless device which is served by the source network device or a source relay wireless device served by the source network device, the handover request comprising identification information of one or more candidate relay wireless devices served by the target network device; selecting a target relay wireless device from the one or more candidate relay wireless devices or a target network device itself to serve the remote wireless device; and transmitting, to the source network device, a handover response, wherein if the target relay wireless device or the target network device itself is selected to serve the remote wireless device, the handover response comprises a container, the container comprising identification information of the target relay wireless device to serve the remote wireless device or cell identification information of the target network device to serve the remote wireless device. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of a method comprising: receiving, from a source network device, a handover request to request handover of a remote wireless device which is served by the source network device or a source relay wireless device served by the source network device, the handover request comprising identification information of one or more candidate relay wireless devices served by the target network device; selecting a target relay wireless device from the one or more candidate relay wireless devices or a target network device itself to serve the remote wireless device; and transmitting, to the source network device, a handover response, wherein if the target relay wireless device or the target network device itself is selected to serve the remote wireless device, the handover response comprises a container, the container comprising identification information of the target relay wireless device to serve the remote wireless device or cell identification information of the target network device to serve the remote wireless device. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of a method comprising: receiving, from a source network device, a handover request to request handover of a remote wireless device which is served by the source network device or a source relay wireless device served by the source network device, the handover request comprising identification information of one or more candidate relay wireless devices served by the target network device; selecting a target relay wireless device from the one or more candidate relay wireless devices or a target network device itself to serve the remote wireless device; and transmitting, to the source network device, a handover response, wherein if the target relay wireless device or the target network device itself is selected to serve the remote wireless device, the handover response comprises a container, the container comprising identification information of the target relay wireless device to serve the remote wireless device or cell identification information of the target network device to serve the remote wireless device. This apparatus may be, for example, an apparatus of a base station (such as a network device 218 that is a base station, as described herein).

Embodiments contemplated herein include a signal as described in or related to one or more elements of a method comprising: receiving, from a source network device, a handover request to request handover of a remote wireless device which is served by the source network device or a source relay wireless device served by the source network device, the handover request comprising identification information of one or more candidate relay wireless devices served by the target network device; selecting a target relay wireless device from the one or more candidate relay wireless devices or a target network device itself to serve the remote wireless device; and transmitting, to the source network device, a handover response, wherein if the target relay wireless device or the target network device itself is selected to serve the remote wireless device, the handover response comprises a container, the container comprising identification information of the target relay wireless device to serve the remote wireless device or cell identification information of the target network device to serve the remote wireless device.

Embodiments contemplated herein include a computer program or computer program product comprising instructions, wherein execution of the program by a processing element is to cause the processing element to carry out one or more elements of a method comprising: receiving, from a source network device, a handover request to request handover of a remote wireless device which is served by the source network device or a source relay wireless device served by the source network device, the handover request comprising identification information of one or more candidate relay wireless devices served by the target network device; selecting a target relay wireless device from the one or more candidate relay wireless devices or a target network device itself to serve the remote wireless device; and transmitting, to the source network device, a handover response, wherein if the target relay wireless device or the target network device itself is selected to serve the remote wireless device, the handover response comprises a container, the container comprising identification information of the target relay wireless device to serve the remote wireless device or cell identification information of the target network device to serve the remote wireless device. The processor may be a processor of a base station (such as a processor(s) 220 of a network device 218 that is a base station, as described herein). These instructions may be, for example, located in the processor and/or on a memory of the base station (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A source network device, comprising:
at least one antenna; and
a processor configured to:
transmit, to a target network device, a handover request to request handover of a remote wireless device which is served by the source network device or a source relay wireless device served by the source network device, the handover request comprising identification information of one or more candidate relay wireless devices served by the target network device; and
receive, from the target network device, a handover response; and
in response to the handover response comprising a container, transmit a handover command comprising the container to the remote wireless device, the container comprising identification information of a target relay wireless device selected by the target network device from the one or more candidate relay wireless devices to serve the remote wireless device or cell identification information of the target network device to serve the remote wireless device.

2. The source network device of claim 1, wherein the processor is further configured to receive, from the remote wireless device, a measurement report comprising cell identification information of the target network device, the identification information of the one or more candidate relay wireless devices served by the target network device, and measurement results of the remote wireless device towards the one or more candidate relay wireless devices.

3. The source network device of claim 2, wherein the measurement report comprises cell identification information of a plurality of network devices, identification information of a plurality of candidate relay wireless devices served by the plurality of network devices, and measurement results of the remote wireless device towards the plurality of candidate relay wireless devices, and
wherein the processor is further configured to select the target network device from the plurality of network devices based on the measurement report.

4. The source network device of claim 3, wherein the measurement report further comprises measurement results of the remote wireless device towards the plurality of network devices.

5. The source network device of claim 3, wherein the handover request further comprises the measurement results of the remote wireless device towards the one or more candidate relay wireless devices.

6. The source network device of claim 4, wherein the handover request further comprises a measurement result of the remote wireless device towards the target network device.

7. The source network device of claim 1, wherein the identification information of the one or more candidate relay wireless devices comprises at least Layer 2 identifiers (L2 IDs).

8. The source network device of claim 1, wherein the container further comprises a configuration of a Sidelink Relay Adaptation Protocol (SRAP) bearer mapping.

9. The source network device of claim 1, wherein the handover response comprises a failure cause value indicating that the one or more candidate relay wireless devices are not found.

10. The source network device of claim 1, wherein the container is transparent to the source network device.

11. The source network device of claim 1, wherein the processor is further configured to:
transmit, to another target network device, another handover request to request handover of the remote wireless device, the another handover request comprising identification information of one or more other candidate relay wireless devices served by the another target network device; and
receive, from the another target network device, another handover response comprising another container, the another container comprising identification information of another target relay wireless device selected by the another target network device from the one or more other candidate relay wireless devices to serve the remote wireless device or cell identification information of the another target network device to serve the remote wireless device.

12. A target network device, comprising:
at least one antenna; and
a processor configured to:
receive, from a source network device, a handover request to request handover of a remote wireless device which is served by the source network device or a source relay wireless device served by the source network device, the handover request comprising identification information of one or more candidate relay wireless devices served by the target network device;
select a target relay wireless device from the one or more candidate relay wireless devices or the target network device itself to serve the remote wireless device; and
transmit, to the source network device, a handover response,
wherein if the target relay wireless device or the target network device itself is selected to serve the remote wireless device, the handover response comprises a container, the container comprising identification information of the target relay wireless device to serve the remote wireless device or cell identification information of the target network device to serve the remote wireless device.

13. The target network device of claim 12, wherein the target relay wireless device is selected based at least on a Radio Resource Control (RRC) state of the target relay wireless device.

14. The target network device of claim 12, wherein the handover request further comprises a measurement result of the remote wireless device towards the target network device, and the processor is configured to select the target relay wireless device or the target network device itself to serve the remote wireless device based at least on the measurement result of the remote wireless device towards the target network device.

15. The target network device of claim 12, wherein the handover request further comprises measurement results of the remote wireless device towards the one or more candidate relay wireless devices, and the processor is configured to select the target relay wireless device or the target network device itself to serve the remote wireless device based at least on the measurement results of the remote wireless device towards the one or more candidate relay wireless devices.

16. The target network device of claim 12, wherein the processor is further configured to transmit an RRC reconfiguration message to the target relay wireless device if the target relay wireless device is in an RRC connected state, so as to reconfigure a Sidelink Relay Adaptation Protocol (SRAP) bearer mapping for the target relay wireless device.

17. The target network device of claim 16, wherein the container further comprises a configuration of the Sidelink Relay Adaptation Protocol (SRAP) bearer mapping.

18. The target network device of claim 12, wherein the processor is further configured to assign identification information to the remote wireless device, and wherein the container further comprises the identification information of the remote wireless device.

19. The target network device of claim 18, wherein the identification information assigned to the remote wireless device is used at least in a Sidelink Relay Adaptation Protocol (SRAP) header.

20. The target network device of claim 12, wherein if none of the one or more candidate relay wireless devices is found, the handover response comprises a failure cause value indicating that the one or more candidate relay wireless devices are not found.

21-27. (canceled)
